(19) United States
(12) Patent Application Publication
(10) Pub. No.: US 2025/0388326 A1
(43) Pub. Date: Dec. 25, 2025

(54) SEAT

(71) Applicant: Hyundai Transys Inc., Seosan-si (KR)

(72) Inventors: Hyung Rae KIM, Hwaseong-si (KR); Do Hyung KIM, Hwaseong-si (KR); Dong Hwan KIM, Hwaseong-si (KR); Jae Eun KIM, Hwaseong-si (KR); Dong Sun SHIM, Hwaseong-si (KR); Hyun Ji LEE, Hwaseong-si (KR)

(21) Appl. No.: 19/237,401

(22) Filed: Jun. 13, 2025

(30) Foreign Application Priority Data
Jun. 19, 2024 (KR) 10-2024-0079841

(51) Int. Cl. B64D 11/06

(52) U.S. Cl. CPC B64D 11/0648; B64D 11/0639; B64D 11/0649; B64D 11/0696

(57) ABSTRACT

A seat includes: a center pipe extending in a width direction; main frames respectively coupled to opposite ends of the center pipe and extending in a vertical direction, each of the main frames having a lower end connected to a floor of a mobility device; a sub-frame fixed to the center pipe between the main frames; and a seat cushion frame having coupling portions at a plurality of positions. Each of the coupling portions is hinge-connected to one of the main frames and the sub-frame, and is restricted from rotating when supported by the one of the main frames and the sub-frame.

### CROSS-REFERENCE TO RELATED APPLICATION

This application is based on and claims priority under 35 U.S.C. 119 to Korean Patent Application No. 10-2024-0079841, filed on Jun. 19, 2024, in the Korean Intellectual Property Office, the disclosure of which is herein incorporated by reference in its entirety.

### BACKGROUND OF THE DISCLOSURE

### 1. Field of the Disclosure

The present disclosure relates to a seat that is applicable to air mobility device or the like.

### 2. Description of the Background Art

Advanced air mobility device (AAM) includes UAM, eVTOL, UAS, and the like, which are electrically powered, vertical takeoff and landing aircraft. Various studies are being conducted in areas such as batteries, autonomous operation, and safety enhancement to enable the commercialization of air mobility device.

The foregoing described as the background art is intended merely to aid in the understanding of the background of the present disclosure, and is not intended to mean that the present disclosure falls within the purview of the related art already known to those skilled in the art.

### SUMMARY OF THE DISCLOSURE

Weight reduction of air mobility device enables improvement in energy efficiency, for example, by increasing the flight range and the load-carrying capacity of the air mobility device. The present disclosure provides a lightweight seat suitable for application to air mobility device and ensures that the seat provides sufficient functionality for passengers on board the air mobility device.

The technical subjects pursued in the present disclosure may not be limited to the above-mentioned technical subjects, and other technical subjects which are not mentioned herein may be clearly understood from the following description by those skilled in the art to which the present disclosure pertains.

In view of the foregoing, a seat according to the present disclosure includes: a center pipe extending in a width direction of the seat; main frames respectively coupled to opposite ends of the center pipe, each of the main frames extending from a first end to a second end, the first end being configured to be connected to a floor of a mobility device; a sub-frame fixed to the center pipe between the main frames; and a seat cushion frame having coupling portions at a plurality of positions. Each of the coupling portions is hinge-connected to each of the main frames or the sub-frame, each of the coupling portions being configured to be restricted from rotating when supported by each of the main frames or the sub-frame.

A plurality of insertion holes spaced apart from each other may be positioned on one side of the seat cushion frame, and the seat may further include a fixing module having one end configured to be inserted into one of the plurality of insertion holes of the seat cushion frame to fix the seat cushion frame.

The one end of the fixing module may be configured to be disengaged from the one of the plurality of insertion holes of the seat cushion frame by an external force, turning the seat cushion frame into a deployable or storable state.

The fixing module may include: a fixing pin configured to be inserted into the one of the plurality of insertion holes so as to fix the seat cushion frame or to be disengaged from the one of the plurality of insertion holes so as to turn the seat cushion frame into a deployable or storable state; and a strap configured to apply an external force to the fixing pin to disengage one end of the fixing pin from the one of the plurality of insertion holes.

The strap may be disposed on the seat cushion frame, and the fixing pin may be disposed on one side of one of the main frames.

The one of the main frames may include on one side thereof a through-hole configured to receive therethrough the one end of the fixing pin.

Each of the coupling portions of the seat cushion frame may include on one side thereof a guide groove configured to guide the one end of the fixing module, which has been disengaged from the one of the plurality of insertion holes, to be inserted into another of the plurality of insertion holes.

At least one frame of the main frames and the sub-frame may include on one side thereof a receiving groove configured to receive each of the coupling portions of the seat cushion frame, and an end of each of the coupling portions may include a support protrusion protruding outward, and a lower end of the receiving groove may include a stopper configured to engage and come into contact with the support protrusion to support the seat cushion frame.

The seat cushion frame is a pair of seat cushion frames, the sub-frame is a pair of sub-frames, and the coupling portions of each of the pair of seat cushion frames may be respectively coupled to one of the main frames and one of the pair of sub-frames.

The seat cushion frame may be a single seat cushion frame, and the coupling portions of the seat cushion frame may be coupled to either the main frames or the sub-frame.

The seat may further include rails configured to be disposed on an upper surface of the floor, and the main frames are respectively connected to the rails and movable along a longitudinal direction of the rails.

Each of the main frames may have a shape opened on one side thereof, and a plurality of first ribs may be positioned on the opened side.

The seat may further include a seat back frame having multiple bent portions and interconnecting upper ends of the main frames and the sub-frame.

Each of the main frames may have a length greater than the sub-frame, and the sub-frame may have a side width greater than a side width of each of the main frames.

The sub-frame may have a shape opened on one side thereof, and a plurality of second ribs may be positioned on the opened side of the sub-frame.

The opened side of one of the main frames and the opened side of the sub-frame may face each other.

All of the main frames and the sub-frame each may include on one side thereof the receiving groove, the coupling portions being hinge-connected inside the receiving grooves, respectively.

The support protrusion and the stopper may be configured to prevent a distal end of respective each of the coupling portions from being in contact with an inner surface of the receiving groove, when viewed from a side cross-section of the seat cushion frame, in a deployed state of the seat cushion frame.

The center pipe, the main frames, and the sub-frame each may include aluminum or an alloy containing aluminum.

The plurality of first ribs may have a zigzag shape continuously connected to each other and to a portion of each of the main frames coupled to the center pipe.

According to the present disclosure, it is possible to provide a seat that allows multiple passengers to be seated and supports the load of multiple passengers. It is also possible to provide a lightweight seat with a compact structure, leading to increased flight range, improved energy efficiency, increased payload capacity, and the like of the air mobility device.

In addition, when the seat is not in use, the seat cushion frame may be folded and stored, and the space created by the folding of the seat cushion frame may be utilized to load cargo or store passengers' luggage.

In addition to the folding of the seat cushion frame, the seat itself is also slidable, allowing for versatile use of space inside the air mobility device.

Advantageous effects obtainable from the present disclosure may not be limited to the above-mentioned effects, and other effects which are not mentioned herein may be clearly understood from the following description by those skilled in the art to which the present disclosure pertains.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is a view illustrating seats according to a first embodiment of the present disclosure;

FIG. 2 is a view illustrating a seat according to a second embodiment of the present disclosure;

FIG. 3 is an exploded view of a seat cushion frame of a seat according to the first embodiment of the present disclosure;

FIG. 4 is a side cross-sectional view of the seat cushion frame;

FIGS. 5 and 6 are cross-sectional views illustrating a receiving groove according to the rotational operation of the seat cushion frame;

FIG. 7 is a view illustrating a seat in which a fixing module is additionally provided;

FIGS. 8 and 9 are views each illustrating the fixing module provided on the seat; and

FIG. 10 illustrates an operational state of a fixing pin of the fixing module.

### DETAILED DESCRIPTION OF THE EXEMPLARY EMBODIMENTS

In describing the embodiments set forth herein, a detailed description of known functions or configurations incorporated herein will be omitted when it is determined that the description may make the subject matter of the embodiments set forth herein unclear. In addition, it should be appreciated that the accompanying drawings are provided only for the sake of easy understanding of the embodiments set forth herein, and the technical idea of the present disclosure is not limited to the accompanying drawings and includes all modifications, equivalents, or alternatives falling within the spirit and scope of the present disclosure.

Terms including an ordinal number such as “a first” and “a second” may be used to describe various elements, but the elements are not limited to the terms. The above terms are used merely for the purpose of distinguishing one element from other elements.

A singular expression may include a plural expression unless they are definitely different in a context.

As used herein, the expression “include” or “have” is intended to specify the existence of mentioned features, numbers, steps, operations, elements, components, or combinations thereof, and should be construed as not precluding the possible existence or addition of one or more other features, numbers, steps, operations, elements, components, or combinations thereof.

The terms “module” and “unit” used for the elements in the following description are given or interchangeably used in consideration of only the ease of writing the specification, and do not have distinct meanings or roles by themselves.

In the case where an element is referred to as being “connected” or “coupled” to any other elements, it should be understood that not only the element may be directly connected or coupled to the other elements, but also another element may exist therebetween. Contrarily, in the case where an element is referred to as being “directly connected” or “directly coupled” to any other element, it should be understood that no other element exists therebetween.

For reference, in the present specification, mobility device refers to a means capable of transporting people or goods. That is, mobility device refers to an apparatus such as an automobile, an airplane, or a drone. Mobility device may be driven by an internal combustion engine, but in recent years, due to environmental regulations for sustainable development or the like, mobility device may also be driven by a battery in which electric power is stored.

Hereinafter, embodiments set forth herein will be described in detail with reference to the accompanying drawings, and the same or similar elements are given the same and similar reference numerals regardless of figure numbers, so duplicate descriptions thereof will be omitted.

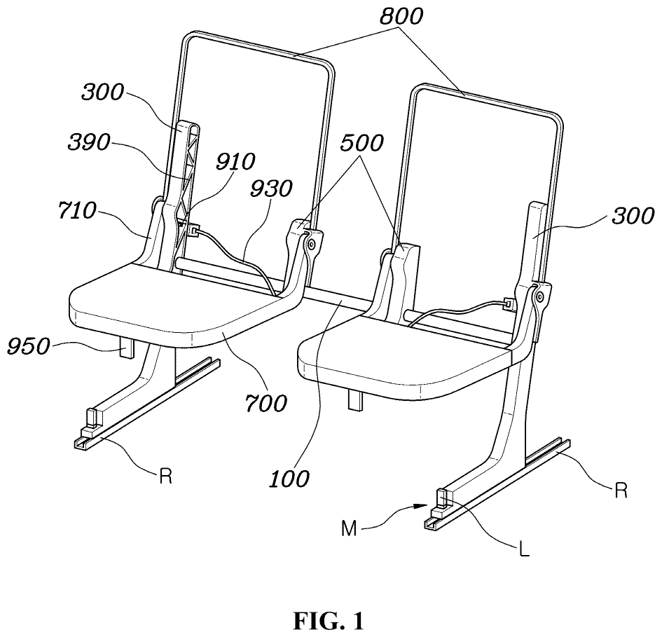

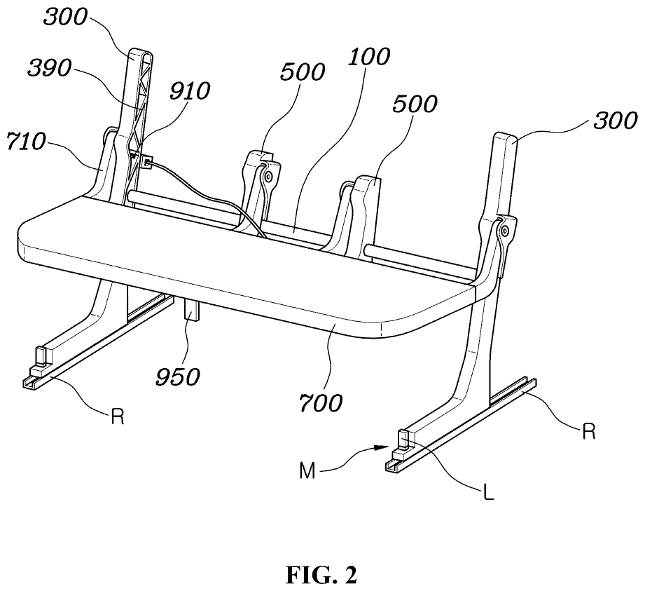

FIG. 1 illustrates a seat according to a first embodiment of the present disclosure, and FIG. 2 is a view illustrating a seat according to a second embodiment of the present disclosure.

A seat according to the present disclosure includes: a center pipe 100 extending in a width direction; main frames 300 respectively coupled to opposite ends of the center pipe 100, extending in a vertical direction, and each having a lower end connected to a floor; a sub-frame 500 fixed to the center pipe 100 between the main frames 300; and a seat cushion frame 700 having coupling portions 710 provided at a plurality of positions, each of the coupling portions 710 being hinge-connected to either a main frame 300 or the sub-frame 500 to form a structure of a seat cushion, and supported by the corresponding main frame 300 or sub-frame 500 in a state of being deployed forward, such that downward rotation is restricted.

Referring to FIGS. 1 and 2, the seat according to the present disclosure may be implemented as a first embodiment in which a pair of seat cushion frames 700 is provided, or as a second embodiment in which a single seat cushion frame 700 is provided. When a pair of seat cushion frames 700 is provided, a space may be secured between passengers to provide a comfortable seating environment. When a single seat cushion frame 700 is provided, there is an advantage in that multiple passengers may be seated on the provided seat cushion.

To provide the seats according to the above embodiments, the center pipe 100, a pair of main frames 300, and one or more sub-frames 500 may be provided.

The center pipe 100 connects the pair of main frames 300. The main frames 300 are spaced apart from each other and coupled to the opposite ends of the center pipe 100. By coupling the center pipe 100 and the main frames 300, a basic seat frame is provided.

In the case of the second embodiment, the coupling portions 710 are provided at one end and the other end of the seat cushion frame 700, and the coupling portions 710 may be respectively coupled to the pair of main frames 300 to provide a bench-type seat. However, to stably support the seat cushion frame 700, a sub-frame 500 may be provided to be fixed to the center pipe 100, and a plurality of coupling portions 710 may be provided on the seat cushion frame 700, such that the coupling portions 710 are hinge-connected to the main frames 300 and the sub-frame 500, as illustrated in FIG. 2.

The center pipe 100, the main frames 300, and the sub-frame 500 may all be made of aluminum or an alloy containing aluminum, and each component may be joined by welding. Aluminum may be a suitable material for manufacturing the seat of the present disclosure, as it helps to form a lightweight frame while also providing appropriate rigidity.

In addition, each main frame 300 has a shape of a member opened at one side, and a plurality of ribs 390 are formed on the open side of the main frame 300 so as to achieve both weight reduction and sufficient rigidity of the main frame 300. That is, aluminum is formed into a member shape opened at one side, allowing for weight reduction of the seat by eliminating unnecessary weight, and ribs 390 may be added to ensure sufficient rigidity of the main frame 300.

Meanwhile, the sub-frame 500 also has a shape of a member opened at one side, like the main frame 300, and a plurality of ribs 390 are formed on the open side thereof to achieve both weight reduction and sufficient rigidity of the seat. In this case, the ribs 390 may be formed in a zigzag shape continuously connected to each other.

A coupling portion 710 of the seat cushion frame 700 is hinge-connected to one side of each of the main frames 300 and the sub-frame 500, so that the seat cushion frame 700 may be deployed during use of the seat and folded for storage when not in use. Meanwhile, although there is little issue when the seat cushion frame 700 is stored, when the seat cushion frame 700 is in use, passengers are expected to be seated on the seat cushion frame 700, and thus the seat should sufficiently support the load of the passengers to ensure stable seating.

That is, the seat cushion frame 700, which is rotatably connected to the main frames 300 or the sub-frame 500, should be fixed at a specific position when the passengers are seated on the seat, so as to support the passengers' load. To this end, when the seat cushion frame 700 is deployed and passengers are seated, the main frames 300 or the sub-frame 500 may restrict further rotation of the coupling portions 710 of the seat cushion frame 700 after they rotate by a predetermined angle, thereby stably supporting the load of passengers.

In this case, when the coupling portions 710 of the seat cushion frame 700 come into contact with the main frames 300 or the sub-frame 500, either the bending angles of the coupling portions 710 may be adjusted, or the contact positions between one ends of the coupling portions 710 and the main frames 300 or the sub-frame 500 may be adjusted, so that the angle formed between the seat cushion frame 700 and the main frames 300 or the sub-frame 500 becomes 90 degrees or greater.

More specifically, one side of at least one of the main frames 300 and the sub-frame 500 may include a receiving groove 310 or 510 configured to receive a coupling portion 710 of the seat cushion frame 700. An end of the coupling portion 710 may be provided with a support protrusion 711 protruding outward, and a lower end of the receiving groove 310 or 510 may be provided with a stopper 311 or 511 that engages and comes into contact with the support protrusion 711 to support the seat cushion frame 700. The stopper 311 or 511 may also be provided in the sub-frame 500.

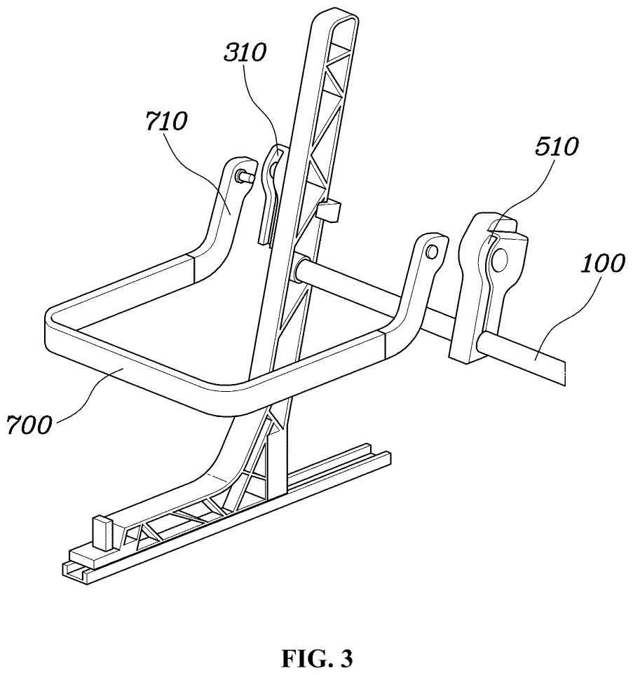

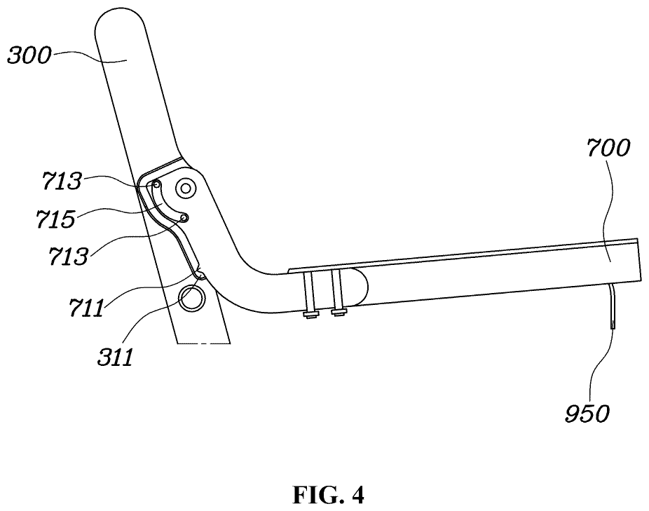

FIG. 3 is an exploded view of a seat cushion frame of a seat according to the first embodiment of the present disclosure, and FIG. 4 is a side cross-sectional view of the seat cushion frame. Referring to FIGS. 3 and 4, it may be seen that the receiving groove 310, to which the coupling portion 710 of the seat cushion frame 700 is hinge-connected, is formed on one side of each of the main frame 300 and the sub-frame 500. The coupling portion 710 of the seat cushion frame 700 is inserted into and received in the receiving groove 310, and then hinge-connected by bolting or the like. As a result, the seat cushion frame 700 is rotatably connected to be deployed or folded.

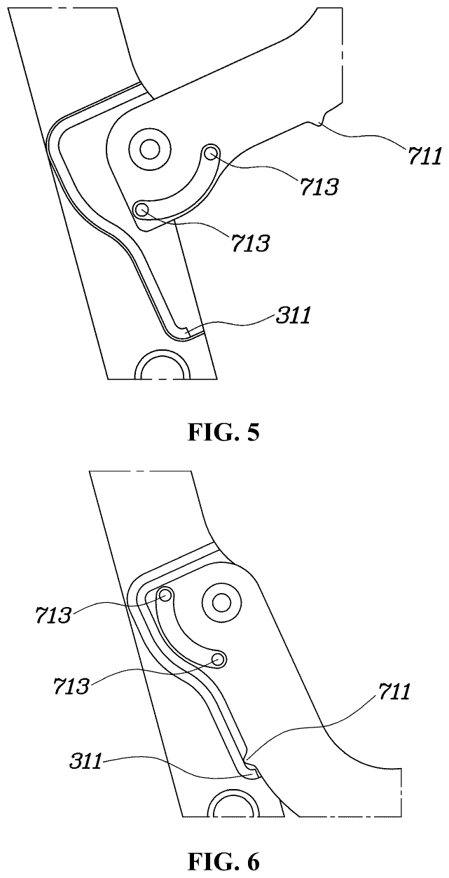

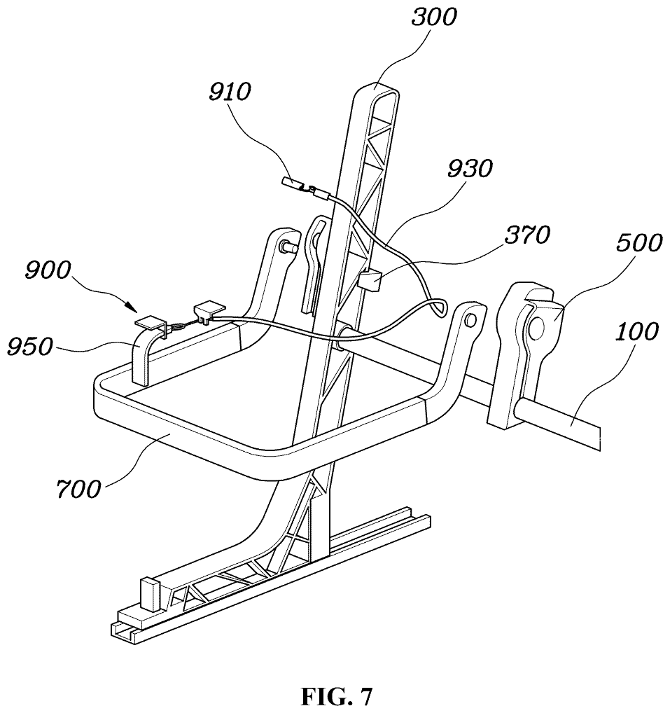

FIGS. 5 and 6 are cross-sectional views of the receiving groove according to the rotational operation of the seat cushion frame. FIG. 5 illustrates a state in which the seat cushion frame is folded, and FIG. 6 illustrates a state in which the seat cushion frame is deployed. Referring to FIGS. 5 and 6, a support protrusion 711 protruding outward is provided at an end of the coupling portion 710, and a stopper 311 is provided at an end of the receiving groove 310 to engage and come into contact with the support protrusion 711 when the seat cushion frame 700 is deployed. After the seat cushion frame 700 is rotated by a predetermined angle, the stopper 311 restricts further rotation of the seat cushion frame 700. Through the contact between the support protrusion 711 and the stopper 311, the load of a passenger seated on the seat cushion may be stably supported.

Meanwhile, a rail R is provided on an upper surface of a floor, and the main frame 300 is connected to the rail R so as to be movable along the longitudinal direction of the rail R. The rail R has a lower surface coupled to the floor and extends in the longitudinal direction, and the main frame 300 is connected to an upper surface of the rail R.

The main frame 300 is connected to be slidable along the longitudinal direction of the rail R on the upper surface of the rail R. In particular, a mount portion M is provided at the lower end of the main frame 300, and one end of the mount portion M is inserted into the interior of the rail R, so that the main frame 300 is connected to the rail R. In particular, a lever L is provided at one end of the mount portion M to fix the position of the main frame 300 or to allow the main frame 300 to be in a slidable state. When the lever L is released, the fixed state of the main frame 300 is released, allowing the seat position to be adjusted by sliding the main frame 300. The seat position may then be fixed again by fixing the lever L.

Accordingly, when an air mobility device is used for cargo transportation or when the number of passengers on board the air mobility device is small, seat cushion frames 700 may be folded, and seats may be stored together to one side of the air mobility device, thereby securing a large space inside the air mobility device.

Meanwhile, the seat according to the present disclosure may further include a fixing module 900 configured to fix the position of the seat cushion frame 700. The fixing module 900 ensures that the position of the seat cushion frame 700 is fixed in either the deployed state or the folded state. More specifically, the seat cushion frame 700 has on one side thereof a plurality of insertion holes 713 spaced apart from each other. One end of the fixing module 900 may be inserted into one of the insertion holes 713 of the seat cushion frame 700 so as to fix the seat cushion frame 700.

The fixing module may be controlled by a control means such as a controller, but to reduce the weight of the seat, one end of the fixing module 900 may be configured to be disengaged from the insertion holes 713 by an external force. That is, one end of the fixing module 900 is disengaged from the insertion holes 713 of the seat cushion frame 700 by an external force applied by a passenger. Accordingly, the seat cushion frame 700 may be turned into a deployable or storable state.

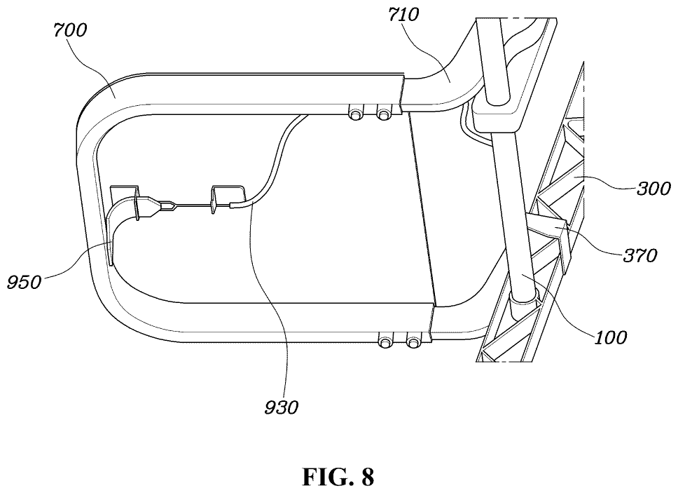

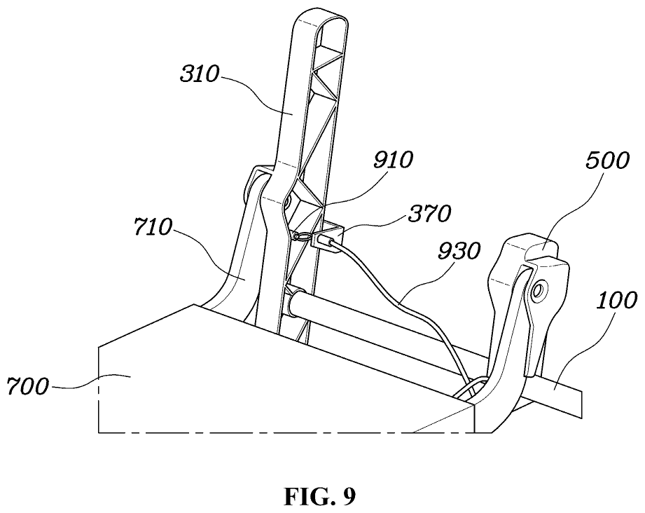

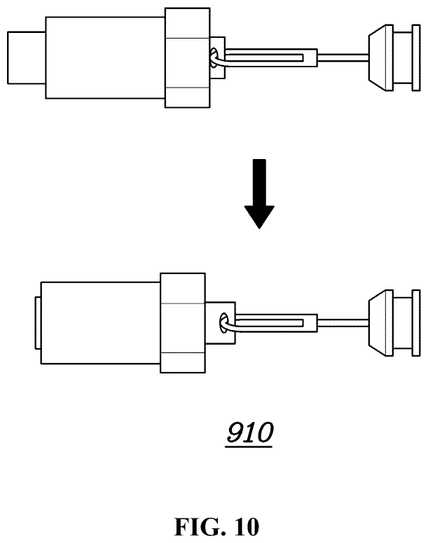

Specifically, the fixing module 900 may be provided across the seat cushion frame 700, the main frame 300, the sub-frame 500, or the like. FIG. 7 illustrates a seat in which a fixing module is additionally provided, FIGS. 8 and 9 illustrate the fixing module provided on the seat, and FIG. 10 illustrates an operational state of a fixing pin of the fixing module.

Referring to FIGS. 7 to 10, the fixing module 900 may include a fixing pin 910 configured such that one end thereof is inserted into an insertion hole 713 to fix the seat cushion frame 700 or is disengaged therefrom so as to bring the seat cushion frame 700 into a deployable or storable state, and a strap 950 configured to apply an external force to the fixing pin 910 so as to disengage the one end of the fixing pin 910 inserted into the insertion hole 713.

Specifically, the strap 950 may be provided on a lower surface of the seat cushion frame 700, and the fixing pin 910 may be provided on one side of the main frame 300. The fixing pin 910 and the strap 950 are connected via a wire 930. That is, one end of the wire 930 is coupled to the fixing pin 910, and the other end of the wire 930 is coupled to the strap 950. Accordingly, when a passenger pulls the strap 950, the external force is transmitted to the fixing pin 910, and one end of the fixing pin 910 moves inward as illustrated in FIG. 10 and is disengaged from the insertion hole 713. As a result, the seat cushion frame 700 is brought into a rotatable state.

A pair of insertion holes 713 may be provided to be spaced apart from each other. One of the insertion holes 713 fixes the seat cushion frame 700 in a deployed state, and the other fixes the seat cushion frame 700 in a folded state.

A guide groove 715 may be formed on one side of the coupling portion 710 of the seat cushion frame 700 to guide one end of the fixing module 900, which has been disengaged from one insertion hole 713, to be inserted into the other insertion hole 713. An elastic element is provided inside the fixing pin 910 to push the one end of the fixing pin 910 outward, and when an external force is applied to the fixing pin 910, the elastic element is contracted to allow the one end of the fixing pin to move inward.

That is, when an external force is applied to the fixing module 900, the one end of the fixing pin 910 is disengaged from the insertion hole 713, but when the external force is removed, the one end of the fixing pin 910 is inserted back into the insertion hole 713.

Meanwhile, in order to facilitate the rotation of the seat cushion frame 700, the guide groove 715 may be formed on one side of the coupling portion 710 of the seat cushion frame 700 to guide the one end of the fixing module 900, which has been disengaged from one insertion hole 713, to be inserted into another insertion hole 713. The guide groove 715 has a groove shape recessed inward relative to the surrounding area and extends so as to connect the plurality of insertion holes 713 to each other. The guide groove 715 may have a streamlined shape.

Meanwhile, when an external force is applied to the fixing module 900, the one end of the fixing pin 910 is disengaged. In this case, the seat cushion frame 700 is turned into a rotatable state, and when the external force applied to the strap 950 is released while the passenger slightly moves the seat cushion frame 700, the one end of the fixing pin 910 is pushed out by the elastic element and comes into contact with the guide groove 715. Thereafter, when the seat cushion frame 700 rotates and the insertion hole 713 located at the other end comes to face the fixing pin 910, the one end of the fixing pin 910 is inserted into the other insertion hole 713, thereby fixing the position of the seat cushion frame 700.

Meanwhile, a through-hole may be formed on one side of the main frame 300 to allow the one end of the fixing pin 910 to pass therethrough. Referring to FIGS. 7 to 9, the fixing pin 910 may be provided on a side portion of the main frame 300. Accordingly, one end of the fixing pin 910 may pass through the main frame 300 to be inserted into an insertion hole 713 of the coupling portion 710 of the seat cushion frame 700.

The fixing pin 910 itself may be provided on one side of the main frame 300 by being welded to the main frame 300 or fitted into the main frame 300, and the other end of the fixing pin 910 may be coupled to an end of the wire 930. A support 370 connected to the main frame 300 may be provided at the position where the end of the wire 930 is coupled.

When an external force is applied to the fixing pin 910, the one end of the fixing pin 910 is disengaged from the insertion hole 713, but may be located in the through-hole.

Meanwhile, a seat according to an embodiment of the present disclosure may further include a seat back frame 800 that is bent multiple times and connects upper ends of main frames 300 or sub-frames 500. Referring to FIG. 1, the seat back frame 800 may be coupled to side surfaces of the main frames 300 or the sub-frames 500. The seat back frame 800 may be connected to upper ends of the main frames 300 or the sub-frames 500 to provide a structure of a seat back.

The seat back frame 800 may connect the main frames 300 and the sub-frames 500 and may interconnect the upper ends of a pair of main frames 300 located at the opposite ends of the center pipe 100 to provide a structure of a seat back.

When the main frames 300 and the sub-frames 500 are connected, the maximum passenger load supported by the seat back frame 800 may increase. Therefore, it may be highly preferred that the seat back frame 800 is provided to interconnect all of the main frames 300 and the sub-frames 500.

A single seat back frame 800 may be provided, or multiple seat back frames 800 may be provided. That is, a single seat back frame 800 may be provided to connect a pair of main frames 300 and a pair of sub-frames 500.

Alternatively, a single seat back frame 800 may be provided to connect one main frame 300 and one sub-frame 500, and one or more pairs of seat back frames 800 may be provided. Referring to FIG. 1, the main frames 300 and the sub-frames 500 have different lengths. This is to reduce the total weight of seats, and in the case of the sub-frames 500, it is sufficient to secure only the weight necessary to reliably restrict the rotation of the seat cushion frames 700.

Specifically, the main frames 300 have a thickness similar to that of the sub-frames 500, but have a longer length than the sub-frames 500. Accordingly, the seat back frames 800 may be stably coupled to side surfaces of the main frames 300.

The sub-frames 500 have a slightly smaller length than the main frames 300. Therefore, considering that the seat back frames 800 will be connected thereto, the sub-frames 500 may be manufactured to have a predetermined or greater side width and side length so as to ensure that the sub-frames 500 have a sufficient coupling area.

Although the present disclosure has been described and illustrated in conjunction with particular embodiments thereof, it will be apparent to those skilled in the art that various improvements and modifications may be made to the present disclosure without departing from the technical idea of the present disclosure defined by the appended claims.

What is claimed is:

1. A seat comprising:
a center pipe extending in a width direction of the seat;
main frames respectively coupled to opposite ends of the center pipe, each of the main frames extending from a first end to a second end, the first end being configured to be connected to a floor of a mobility device;
a sub-frame fixed to the center pipe between the main frames; and
a seat cushion frame having coupling portions at a plurality of positions, each of the coupling portions being hinge-connected to each of the main frames or the sub-frame, each of the coupling portions being configured to be restricted from rotating when supported by each of the main frames or the sub-frame.

2. The seat of claim 1, wherein a plurality of insertion holes spaced apart from each other are positioned on one side of the seat cushion frame, and
wherein the seat further comprises a fixing module having one end configured to be inserted into one of the plurality of insertion holes of the seat cushion frame to fix the seat cushion frame.

3. The seat of claim 2, wherein the one end of the fixing module is configured to be disengaged from the one of the plurality of insertion holes of the seat cushion frame by an external force, turning the seat cushion frame into a deployable or storable state.

4. The seat of claim 2, wherein the fixing module comprises:
a fixing pin configured to be inserted into the one of the plurality of insertion holes so as to fix the seat cushion frame or to be disengaged from the one of the plurality of insertion holes so as to turn the seat cushion frame into a deployable or storable state; and
a strap configured to apply an external force to the fixing pin to disengage one end of the fixing pin from the one of the plurality of insertion holes.

5. The seat of claim 4, wherein the strap is disposed on the seat cushion frame, and the fixing pin is disposed on one side of one of the main frames.

6. The seat of claim 5, wherein the one of the main frames comprises on one side thereof a through-hole configured to receive therethrough the one end of the fixing pin.

7. The seat of claim 2, wherein each of the coupling portions of the seat cushion frame comprises on one side thereof a guide groove configured to guide the one end of the fixing module, which has been disengaged from the one of the plurality of insertion holes, to be inserted into another of the plurality of insertion holes.

8. The seat of claim 1, wherein at least one frame of the main frames and the sub-frame comprises on one side thereof a receiving groove configured to receive each of the coupling portions of the seat cushion frame, and
wherein an end of each of the coupling portions has a support protrusion protruding outward, and a lower end of the receiving groove has a stopper configured to engage and come into contact with the support protrusion to support the seat cushion frame.

9. The seat of claim 1,
wherein the seat cushion frame is a pair of seat cushion frames,
wherein the sub-frame is a pair of sub-frames, and
wherein the coupling portions of each of the pair of seat cushion frames are respectively coupled to one of the main frames and one of the pair of sub-frames.

10. The seat of claim 1, wherein the seat cushion frame is a single seat cushion frame, and
wherein the coupling portions of the seat cushion frame are coupled to either the main frames or the sub-frame.

11. The seat of claim 1, wherein the seat further comprises rails configured to be disposed on an upper surface of the floor, and the main frames are respectively connected to the rails and movable along a longitudinal direction of the rails.

12. The seat of claim 1, wherein each of the main frames has a shape opened on one side thereof, and a plurality of first ribs are positioned on the opened side.

13. The seat of claim 1, further comprising:
a seat back frame having multiple bent portions and interconnecting upper ends of the main frames and the sub-frame.

14. The seat of claim 1, wherein each of the main frames has a length greater than the sub-frame, and the sub-frame has a side width greater than a side width of each of the main frames.

15. The seat of claim 12, wherein the sub-frame has a shape opened on one side thereof, and a plurality of second ribs are positioned on the opened side of the sub-frame.

16. The seat of claim 15, wherein the opened side of one of the main frames and the opened side of the sub-frame face each other.

17. The seat of claim 8, wherein all of the main frames and the sub-frame each includes on one side thereof the receiving groove, the coupling portions being hinge-connected inside the receiving grooves, respectively.

18. The seat of claim 17, wherein the support protrusion and the stopper are configured to prevent a distal end of respective each of the coupling portions from being in contact with an inner surface of the receiving groove, when viewed from a side cross-section of the seat cushion frame, in a deployed state of the seat cushion frame.

19. The seat of claim 1, wherein the center pipe, the main frames, and the sub-frame each comprises aluminum or an alloy containing aluminum.

20. The seat of claim 12, wherein the plurality of first ribs have a zigzag shape continuously connected to each other and to a portion of each of the main frames coupled to the center pipe.
